(19) United States
(12) Patent Application Publication
(10) Pub. No.: US 2009/0190443 A1
(43) Pub. Date: Jul. 30, 2009

(54) Sunset Timer with Random Automatic Mode

(75) Inventors: Andrew H. Huizi, Hoboken, NJ (US); Myron Hitchcock, Englewood, FL (US); John J. Driska, Princeton Junction, NJ (US)

Correspondence Address: EDELL, SHAPIRO & FINNAN, LLC, 1901 RESEARCH BOULEVARD, SUITE 400, ROCKVILLE, MD, 20850, US

(73) Assignee: JG DIGITAL TECHNOLOGIES, LLC, NEW YORK, NY (US)

(21) Appl. No.: 12/416,428

(22) Filed: Apr. 1, 2009

Related U.S. Application Data
(63) Continuation of application No. 11/028,143, filed on Jan. 3, 2005.

(51) Int. Cl. G04F 10/00; G04B 47/00

(52) U.S. Cl. 368/10; 368/107

(57) ABSTRACT

The present invention generally relates to an electrical timer which automatically controls the activation and deactivation of electrical devices, such as light fixtures, appliances and the like based on the time of sunrise and/or sunset for a particular geographic location. In this regard, the sunrise and/or sunset times for a multitude of different geographic locations is collected and stored in the timer's memory in association with the relevant geographic location. Each geographic location is specified in memory by geographic indicia, such as postal zip code or telephone area code, of its location (e.g., latitude and longitude). The timer of the present invention is programmed to automatically activate and/or deactivate the device to which it is coupled (e.g., lights, appliances, etc.) at the sunset and/or sunrise times stored in memory for each date that is specified in memory.

### CROSS REFERENCE TO RELATED APPLICATIONS

This application is a continuation of U.S. patent application Ser. No. 11/028,143, entitled “Sunset Timer” and filed on 3 Jan. 2005, the disclosure of which is incorporated herein by reference in its entirety.

### FIELD OF THE INVENTION

The present invention generally relates to an electronic timer which automatically controls the activation and deactivation of devices to which it is coupled, such as light fixtures, appliances, and the like, based on the time of sunrise and/or sunset for a particular geographic location.

### BACKGROUND OF THE INVENTION

Electronic timers for controlling the activation and deactivation of light fixtures are well known in the art. Typically, these timers can be programmed by a user to activate or deactivate household lights at a predetermined time. For example, a conventional electronic wall timer could be programmed to activate external lighting at a residence at a predetermined time which is estimated to be the time at which the sun sets. This can be done manually; however, the disadvantage of having to manually set a timer is that the timer will have to be reset periodically in order to adapt the timer to the change in sunset time.

In some cases, an electronic timer is reset automatically. For example, Intermatic, Inc. sells a commercial “heavy duty digital timer,” Model No. DT17, which is pre-programmed to automatically reset the time that the timer will be activated. Such timer divides the continental United States into three zones, a “north” zone, a “center” zone and a “south” zone. Each zone encompasses states in the U.S. which are on the east coast, west coast and regions in between. For example, the “north” zone consists of states in the northern part of the U.S. (e.g., the states of Wash. and Me.); the “center” zone consists of states in the central part of the U.S. (e.g., the states of Pa. and the northern portion of Calif.); and the “south” zone consists of states in the southern part of the U.S. (e.g., the states of Fla. and Ariz.). To program this prior art timer, the user selects one of these three geographic zones which will roughly indicate to the timer a “sun up” and sunset time in that time zone. Alternatively, the user can manually set the timer to coincide with sunrise and sunset times for his specific geographic location, which are typically printed in public sources, such as newspapers.

While potentially useful in some regions of the U.S., this prior art timer cannot be accurately set to automatically activate or deactivate light fixtures at the sunrise and sunset times for all states within a given geographic zone. The sunrise and sunset times for different cities and states within the same geographic zone will vary depending on whether the city is in the eastern or western end of its respective time zone. For example, on Dec. 24, 2003, Portland, Me., had a sunset time of approximately 4:09 p.m., whereas Boise, Id., had a sunset time of 5:13, p.m. While these two cities are both located in the north geographic zone of the prior art, there is more than a one hour difference as to their sunset times since Me. is located at the eastern end of the Eastern Time Zone and Id. is at the western end of the Mountain Time Zone. Thus, in this prior art timer, the timer may activate lights too early in some regions, such as Boise, Id. for example, based on the sunset time in Portland, Me. or too late in Portland, Me., if based on the sunset time for Boise, Id. Moreover, while a user can manually set the prior art timer to coincide with sunset and sunrise times for a particular geographic region, such process is tedious and does not include the advantages inherent to an automated system.

Another example of a device which relies on sunrise and sunset times to control its operation is an “animal feeder” disclosed in U.S. Pat. No. 5,926,441. This feeder ostensibly determines sunrise and sunset times based on information entered into the device by a user, including the date, latitude, longitude and time zone in which the user is located. However, there is no specific teaching as to how the latitude and longitude information is correlated to sunrise/sunset times. Moreover, while the feeder is pre-programmed with default settings for latitude and longitude information, the user must change this information in the feeder to conform to his or her geographic location. To do so, the user must have personal knowledge of the latitude and longitude of the particular geographic location in which he or she is located. As a practical matter, users would not typically know this information and would not be able to set the feeder to accurately operate in conjunction with local sunset and sunrise times.

Thus, there is a long-felt need for an electronic timer which controls the activation and deactivation of electronic devices, such as lights, appliances and the like, which automatically adjusts to changing sunrise and sunset times during the calendar year for a given geographic location, in an accurate manner, yet permits the geographic information to be readily input.

### SUMMARY OF THE INVENTION

Accordingly, it is an object of the present invention to provide an electronic timer which automatically adjusts sunrise and sunset times over a calendar year based on geographic location.

It is another object of the present invention to provide a timer which stores sunrise and sunset times corresponding to an indicator of geographic location, such as, for example, U.S. Postal Service zip codes, telephone area dialing codes, city names, global positioning system information or similar geographic information.

It is still a further object of the present invention to pre-program a timer with sunrise and sunset information for various geographic locations which can be selected and easily set by a user through the use of the aforementioned indicator of geographic location.

It is yet another object to the present invention to provide an easy to use means of inputting the geographic location into the timer.

It is another object of the present invention to solve these and the other shortcomings of the prior art.

Other objects will become apparent from the foregoing description.

It has now been found that the above and related objects of the present invention are obtained in the form of an electronic timer which comprises a display, at least one input key for entering geographic indicia; a memory unit and a microprocessor for controlling at least the memory unit and display. Additionally, a database is stored in the memory unit. This database comprises sunset times for a plurality of geographic locations, wherein the sunset times are indexed to geographic indicia for each of the plurality of geographic locations. Further, software is included in the timer which comprises instructions for actuating an electrical device coupled to the timer at the sunset time indexed to the geographic indicia.

### BRIEF DESCRIPTION OF THE DRAWINGS

The above and related objects, features and advantages of the present invention will be more fully understood with reference to the following detailed description of the preferred, albeit illustrative, embodiment(s) of the present invention when considered in conjunction with the accompanying figures, wherein:

FIG. 1 is a block diagram components of the timer of the present invention;

FIG. 2 is a front view of one embodiment of the timer of the present invention;

FIG. 3 is an enlarged front view of the timer shown in FIG. 2;

FIG. 4 is a front view of the timer shown in FIGS. 2 and 3 showing various operational components;

FIG. 5 is a side view of the timer shown in FIGS. 2-4;

FIG. 6 is a front view of a second embodiment of the timer of the present invention;

FIG. 7 is a plan view of the timer shown in FIG. 6;

FIG. 8 is a front view of a third embodiment of the timer of the present invention; and

FIG. 9 is a plan view of the timer shown in FIG. 8.

### DETAILED DESCRIPTION OF THE INVENTION

The present invention generally relates to an electronic timer which is programmed to automatically activate and deactivate electronic devices to which it is coupled, such as lights (both indoor and outdoor), appliances and the like based on sunrise and sunset times of a particular geographic location.

Over the course of a given year, the sunset and sunrise times will vary from day to day, week to week and month to month. For example, the sunset time in Portland, Me. is approximately 4:09 p.m. on Dec. 24 of each year. As the year progresses, the time of sunset in Portland, Me. occurs later in the day. For example, on Jun. 24 of each year, the sun sets in this city at approximately 7:13 p.m. Similarly, as noted herein, the sunrise and sunset times in their respective time zones for different cities and states throughout the country will vary on any given day. For example, on Dec. 24, the sunset time in Portland, Me. is approximately 4:09 p.m. whereas the sunset time in Boise, Id. is approximately 5:13 p.m. Similarly, on Dec. 24, the sunset time in Seattle, Wash. is approximately 4:22 p.m. whereas the sunset time in San Francisco, Calif. is approximately 4:56 p.m., more than a 30 minute difference even though these cities are relatively close to each other and have approximately the same longitude.

Additionally, certain parts of McCook, Nebr.; Bismarck, N. Dak.; Williston, N. Dak.; and Rapid City, S. Dak. are situated in the Mountain Standard Time (“MST”) zone, while other parts of these regions are situated in the Central Standard Time (“CST”) zone. As a result, the sunset time within these cites will be very different, depending upon whether one is located in the MST or CST zone for these cities. For example, on Mar. 24, the sun sets at approximately 6:10 in the parts of Bismarck, N. Dak. located in the MST zone, whereas the sun sets at approximately 7:02 p.m., in the parts of Bismarck that are located in the CST zone, nearly a one hour difference.

To account for all of the foregoing differences, in one embodiment of the present invention, the sunrise and/or sunset times for a multitude of different geographic locations are collected (e.g. from publicly available sources, such as http://aa.usno.navy.mil/data/docs/RS OneYear.html) for different days of a given year and stored in a database in the timer's memory. The sunset and/or sunrise data can be stored for each day of a year, each week of a year, each month of a year or any combination thereof. According to the present invention, the sunrise and/or sunset times are indexed in the database against geographic indicia associated with such locations. Preferably the geographic indicia should be generally known to the potential user of the timer of the present invention. Some examples of geographic indicia readily known or available to a user of the timer include, but are not limited to, United States Postal Service zip codes, area codes for dialing telephone numbers, international postal or mailing codes, international telephone dialing codes, and/or any other types of readily known indicia of geographic location. Other geographic indicia such as latitude and longitude, GPS positional data or other similar information could be used but are less advantageous because the information is not generally known to the user.

Upon entry of geographic indicia into the timer of the present invention, the circuitry will automatically activate and/or deactivate the device to which it is coupled (e.g., lights, appliances, etc.) in the region where it is located at the sunset and/or sunrise times for each date that is specified in memory. Various exemplary embodiments of the database, software and hardware of the timer of the present invention are described below.

Turning first to the database of the present invention, it is noted that this database is not limited to any particular example and could be organized in any manner. In one embodiment of the present invention, sunrise and/or sunset data is collected for at least one city in each state of the United States for each successive week of a year and stored in a database in association U.S. Postal Service zip codes. As discussed below, the timer can then be set to automatically activate and/or deactivate a device each week to reflect the changing sunset and sunrise times for a given zip code. Moreover, if a zip code for certain regions within a state are not stored in the database, then the timer could be configured to automatically set a default sunset and/or sunrise time for a proximate city within that state that is stored in the database. This could be accomplished in any number of ways which should be apparent to one skilled in the art.

Table 1 is one example of how data can be stored in a database in the timer of the present invention for the cities discussed herein. In this embodiment, the database includes state and city names, the time zone of each of the listed locations, representative U.S. Postal Service zip codes for regions within these locations, and sunset times for various dates of a year with these regions. In this embodiment and for reasons discussed below, only the first three digits of the zip codes for most U.S. cities are stored in memory in association with that region's sunset times; however, for cities located in two different time zones, the full five digit zip codes are stored in memory (and thus occupy more memory space). Alternatively, all five digits of a zip code may be stored in memory for all cities if desired, if memory space permits. TABLE-US-00001 TABLE 1 SUNSET TIMES City, Time March 24 June 24 September 24 December 24 State Zip Code* Zone (p.m.) (p.m.) (p.m.) (p.m.) Huntsville, 357, 358 CST 6:01 7:03 5:40 4:41 AL 356, 359 Portland, 039, 040, Eastern 5:59 7:13 5:35 4:09 ME 041, 042, Standard 043, 045, Time 048 (“EST”) Boise, Id. 833. 835, MST 7:02 8:24 6:38 5:13 836, 837, 839 Bismarck, 58401, CST 7:02 8:41 6:54 4:59 ND 58424, 58431, 58440 58520, MST 6:10 7:50 6:02 4:07 58523, 58529 Williston, 58701, CST 7:34 8:57 7:06 5:05 ND 58730, 58831, MST 6:29 7:48 6:02 4:07 58835, McCook, 68901, CST 6:59 8:16 6:36 5:22 NE 69036 69021 MST 6:12 7:34 5:48 4:29 69025 Rapid 57523, CST 6:52 8:24 6:27 4:55 City, SD 57526 57521, MST 6:11 7:38 5:46 4:19 57543 Seattle, 980, 981 Pacific 6:28 8:11 6:02 4:22 WA 982, 983 Standard 984, 985 Time (“PST”) San 946, 947, PST 6:26 7:35 6:03 4:56 Francisco, 948, 949, CA 950, 951.

In the example shown in Table 1, the stored sunset time is the same for all zips codes commencing with the listed three digit combinations for each city. In accordance with the present invention, by entering any one of the zip codes for the listed cities, the timer will automatically activate the device to which it is coupled (e.g., a light) at the times and date intervals indicated for that region. For example, if a user in Huntsville, Ala. enters a zip code that begins with the digits 356, 357, 358 or 359, the timer will activate a coupled device at 6:01 p.m. between March 15 and June 23. On June 24, the timer will adjust automatically to activate the device at 7:03 p.m. every day until the next listed date (e.g., September 24). This process is repeated only for each time interval in memory, and thus, it is preferred that sunset times be maintained in more frequent periods (e.g., weekly).

Alternatively, where sunset data is only collected for a limited number of dates for each geographic location, the timer could be programmed to extrapolate the sunset times for additional dates (e.g., sunset data for each week of a year) not specified in the database. The timer should activate a coupled device at the extrapolated times between dates for which corresponding sunset times are stored in the database. By operating in this manner, the timer will be able to more closely follow the change in sunset times over the course of a year while at the same time minimizing the amount of memory space needed to store sunset data.

In most cases of the above embodiment, only the first three digits of a zip code are stored in memory. The remaining two digits of the zip code are not material to operation of the present invention and do not necessarily have to be accurately entered for the present invention to work. As noted above, certain parts of McCook, Nebr.; Bismarck, N. Dak.; Williston, N. Dak.; and Rapid City, S. Dak. are situated in the Mountain Standard Time zone, while other parts of these regions are situated in the Central Standard Time zone. Since the first three digits of the zip codes for certain parts of these regions are the same in both time zones within these cities, sunset times for these regions should preferably be stored in association with all five digits of the zip code to account for any differences in sunset times, as shown in Table 1.

The hardware of the timer of the present invention is now described. In an embodiment of the present invention, the timer is a digital timer which is provided with conventional hardware and circuitry known in the art. The timer can be mounted and hard wired in a wall box in place of a light switch, configured to be plugged into an electrical outlet with the device plugged into the timer, or be a table top unit which can be plugged into an electrical outlet or hardwired in place of an electrical outlet. In the case of a hard wired timer, when activated, the timer will cause a light to receive electricity as though the switch had been turned on or off. In the case of a timer plugged into a wall outlet, the timer includes an electrical socket which is controlled by the timer circuitry. A lamp, appliance or similar electrical device can then be plugged into the socket. When the timer activates the socket, the lamp or appliance is correspondingly activated as well. Additionally, the timer may include backup batteries which will retain power in the timer in the event of a power failure, and thus, retain the settings (zip code, activation times, etc.) in the timer.

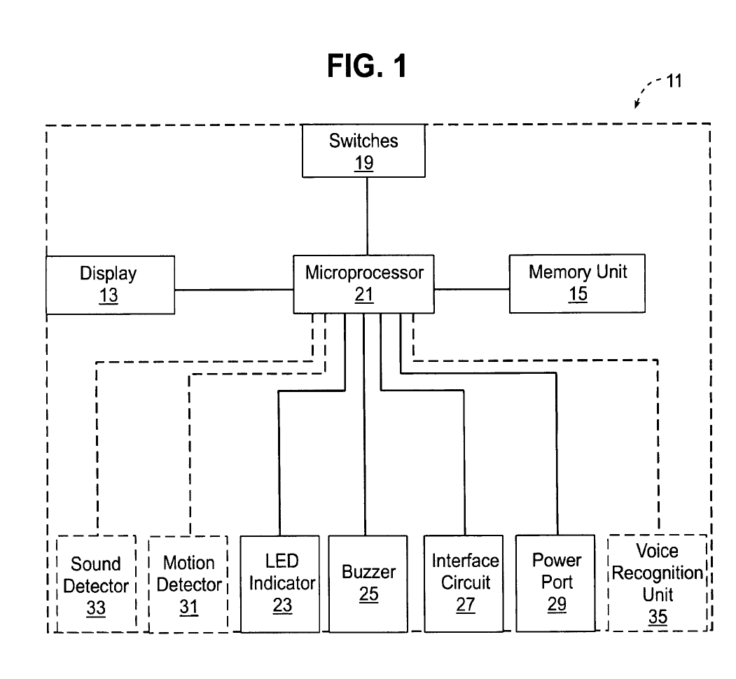

Referring to FIG. 1, the timer 11 includes a display 13, memory unit 15 for storing, among other things, software, logic and a sunset database, switches 19 for operating the timer 11 (e.g., time set, power, zip code, mode, 7-5-2, random, program, power, time adjust, etc. as described below), an LED indicator 23, a buzzer 25, an interface circuit 27 (e.g., a USB port) for loading data into the timer's memory and a power port 29. The buzzer 25 may be used to confirm the accuracy of an entered zip code. For example, if an incorrect zip code is entered, the buzzer may cause the timer to beep to indicate this error. Similarly, the buzzer may be used to indicate to a user that he or she has taken too long in entering settings (e.g., time and date) into the timer and/or to indicate a change in operational modes in the timer. In one embodiment of the timer of the present invention, a commercially available microprocessor 11 is a TENX TM8726 chip, the memory unit 15 is a W551C005 chip and the display 13 is a liquid crystal display, although the present invention is not limited to these examples. Additionally, a motion detector circuit 31, sound detector 33 and/or voice recognition unit 35 may be optionally included in the timer 11. In this embodiment, all of the above components of the timer 11 are coupled to a microprocessor 21 which controls their operation. It should be noted that FIG. 1 is merely illustrative of the present invention and the circuitry for the above components can be configured and varied in any number of ways which will be apparent to one of ordinary skill in the art.

The above components operate to facilitate, among other things, timekeeping functions, the storage and use of geographic indicia and sunset/sunrise times, motion detection, speech recognition, speech synthesis and i/o functionality. The software of the present invention is programmed to carry out at least the following functions of the timer of the present invention: storing the database of sunset and/or sunrise times; extrapolating sunset and/or sunrise data for additional dates based on collected data; recognizing the geographic indicia input into the timer by a user; indexing the sunset and/or sunrise times against the geographic indicia utilized; activating and deactivating devices to which the timer is coupled in accordance with the sunset and/or sunrise times as specified in the database; carrying out the other functions discussed below (e.g., setting the time and date in a clock; overriding the timer function); changing the timer for activating and deactivating the timer as function of the date; recognizing and processing speech and activating the timer in response to the same; processing sound and/or motion and activating the timer in response to the same; and similar functions which are commonly used in conventional timers. Armed with the knowledge of the foregoing functions, the software code for performing these functions should be readily apparent to a software designer.

In a preferred embodiment, the timer of the present invention is preset with default settings for time, date and zip code (e.g., EST time zone and a 10010 zip code). The software of the present invention should be programmed to automatically adjust the time setting to the local time in the time zone for a zip code entered by the user. For example, if a user located in Chicago, Ill. enters his or her zip code, then the preset time in the timer should be automatically adjusted to conform to the current time in the CST time zone. Moreover, even if the zip code feature of the present invention is not included in a timer, conventional timers could be preset with a default time and date, which could be automatically adjusted by indicating the time zone where the timer is located (e.g., through the use of a time zone key).

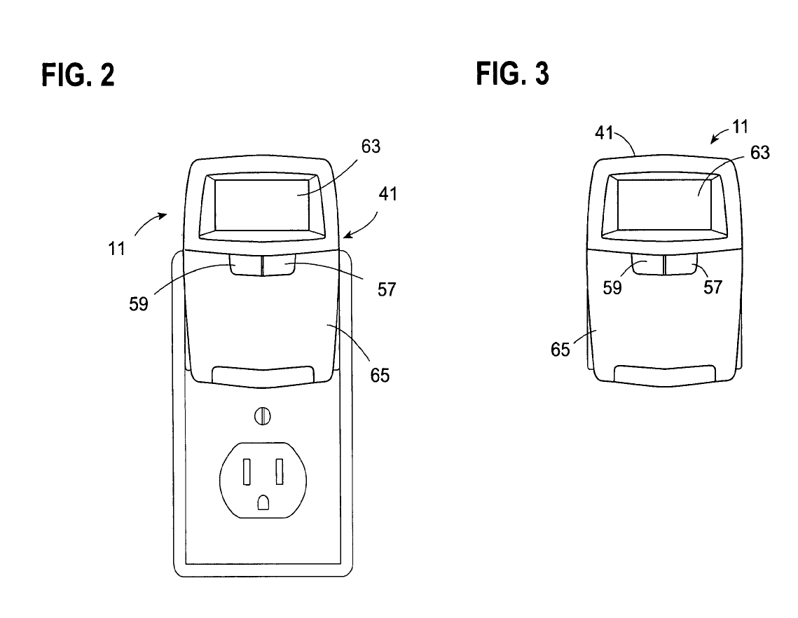

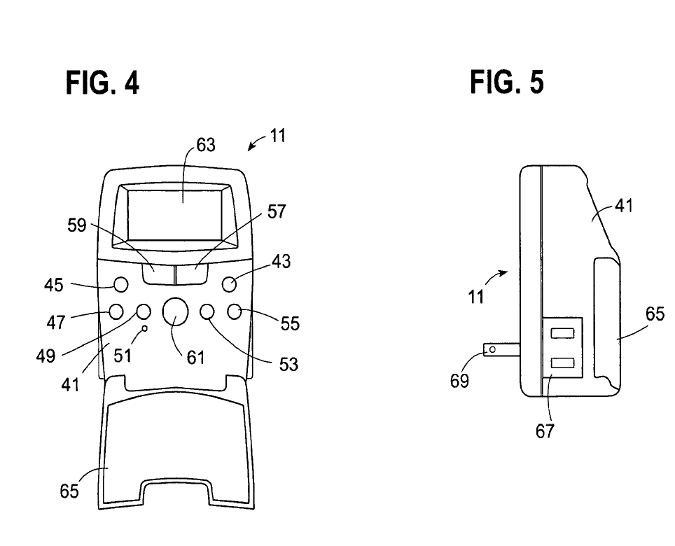

In one embodiment of the timer of the present invention, a digital timer 11 may be wall mounted in an electrical box, free standing, or configured to be plugged into an electrical outlet, as shown in FIG. 2. Referring to FIGS. 2-4, the timer 11 is included within a housing 41 made from plastic or metal, for example. The timer 11 includes a variety of different keys which operate in conjunction with the above described software and circuitry to perform various functions. In the embodiment shown in FIGS. 2-4, soft keys are used to perform a variety of different functions and to enter data into the timer 11. More particularly, as shown in FIG. 4, a program key 43, time set key 45, calendar/7-5-2 key 47, reverse key 49, reset key 51 and an hourly adjust/forward key 53 can be used to set or reset the time and date on the timer 11. Additionally, in this embodiment, the reverse key 49 and forward key 53 can be used to manually activate a coupled device for a preset period of time (e.g., five minutes). A zip code key 55 can be used in conjunction with the soft keys (e.g., reverse key 49 and forward key 53) to enter a zip code in the timer 11 to carry out the method of the present invention. Alternatively, an alphanumeric keypad may be optionally provided to facilitate the entry of time data, zip codes, area codes, etc. Additionally, a dimmer key and related conventional circuitry (not shown) may be included with the timer to allow for dimming of lights coupled to the timer.

Additionally, as shown in FIGS. 2-4, a mode key 57 may be optionally provided to switch the timer between modes of operation. These modes include the geographic indicia entry mode described above, a manual operation mode, an automatic operation mode, and a random automatic mode. In the manual mode, a user can program the timer to activate and deactivate the device to which it is coupled at times of his choosing. In the automatic mode, the timer should be programmed to activate and deactivate a device at specific times in a recurring manner (e.g. activate the device at 6 p.m. and deactivate the device at 11 p.m.). The random automatic mode should operate in a similar manner to the automatic mode, except that it should allow the user to turn the lights on or off at a time which is approximately the sunset and/or sunrise times but varies by approximately 5 to 15 minutes on a random basis so it does not appear that the activation is precisely controlled each day. Thus, if a potential thief is watching a house, the lights will not go on and off at precisely the same time each day, making it appear that someone at home is manually activating the lights. For ease of use, a separate random button may be included in the timer. If desired, a separate random key 59 may be provided on the timer, as shown in FIGS. 2-4.

The 7-5-2 key 47 on the timer permits a user to program the timer to activate and/deactivate devices at the same time for all seven days of the week or at one set of times for five days a week (e.g., Monday-Friday) and at a different set of times two days a week (e.g., Saturday and Sunday). As should be appreciated, this optional feature allows the user to program the timer to operate differently during a “work week” than it does on weekends, without requiring the user to reprogram the timer for each of these timer periods.

In the present invention, the manual mode, random mode, random automatic mode and 7-5-2 mode can be entered and exited on the fly without resetting the existing settings in the timer. For example, if the timer is set in the zip code mode and a user enters the random automatic mode on a particular day, the zip code settings will remain in the timer and the timer will revert to the zip code mode when the random automatic mode is exited. Additionally, it is noted that for ease of operation, the keys for the random automatic mode, manual mode, zip code mode and/or 7-5-2 mode may be exposed on the face of the timer so as to allow easy access to these keys, as shown in FIGS. 2-4.

Further, in each embodiment described herein, the manual mode, random mode, random automatic mode, 7-5-2 mode and/or zip code mode may be adjusted forward or backwards by specific, preset time intervals using on time hourly adjust and best fit logic programmed into the timer. More particularly, when a timer is set to activate a device at a specific time in any of these modes, the on time hourly adjust logic programmed into the timer will allow a user to manually adjust the activation time by preset time increments without requiring the settings in the timer to be reset. For example, if the timer is set to activate lights at 4:30 p.m., the user can adjust this time by 10 minute intervals through the use of the on time hourly adjust logic and time set keys (e.g., the reverse key 49 or the forward key 53). Thus, in this example, the user can adjust the timer to activate the lights at an earlier time, such as 4:20 p.m., 4:10 p.m., etc., or at a later time, such as 4:40 p.m., 4:50 p.m., etc. Of course, the preset time intervals may be varied to be longer or shorter, if desired. In this embodiment, the on time hourly adjust logic should be configured with a maximum number of time intervals which could be changed in the timer (e.g., nine ten-minute time intervals for a total 90 minutes in either direction).

Additionally, the timer should be programmed with best fit logic to prevent a user from adjusting the time settings through the on time hourly adjust logic beyond the time for which the coupled device is set to deactivate. In this regard, if the timer is set to activate at 6 p.m. and deactivate at 7 p.m., and a user attempts to adjust the time settings to activate a coupled device at a time coinciding with or occurring after the deactivation time (e.g., 7:10 p.m.), the best fit logic will automatically prompt the timer to allow for a change which will activate the device at a time which fits best within the previously set activation and deactivation times. In the above example, the best fit logic will allow for a change of activation time of no later than 6:50 p.m.

Additionally, the timer may be equipped with a daylight savings key (not shown) which can be used to change the time during daylight savings periods without having to manually reset the timer. Alternatively, the daylight savings slide switch may be provided to perform the same function. Additionally, an “on/off” key 61 may be provided to turn the timer on and off, manually. Alternatively, manually activating such key can cause the timer to stay activated for a predetermined period (e.g., 15 minutes). This feature allows the user to return to the house, temporarily activate the timer, leave the house and have the timer resume normal operation without the need for further resetting or activating. It should be noted that the present invention is not limited to the keys described herein, as additional or fewer keys can be implemented to carry out the functions of the timer, depending upon its design. A display 63 is provided in which information entered using the foregoing keys can viewed and edited. Additionally, the timer of the present invention may be programmed to be operated by a remote control device through well known methods in the art.

Further, a retractable cover 65 may be hingedly mounted to the timer to enclose these keys, if desired, as shown in FIG. 2. Instructions for operating the timer may be printed on the inner surface of the cover. In this embodiment, the timer includes a plug 69 which can be configured in an electrical outlet to provide power to the timer, as shown in FIG. 5. Additionally, one or more courtesy outlets 67 can also be provided with the timer. In this regard, since the timer of the present invention may be plugged into an electrical outlet or hardwired in a wall socket in place of an electrical outlet, the electrical outlet/wall socket where the timer is configured is not free to have other electrical devices plugged in. The courtesy outlet 67 operates similar to an extension cord in that it conducts electricity from the electrical wiring in the walls and therefore allows devices to be plugged in and operate independent from the timer.

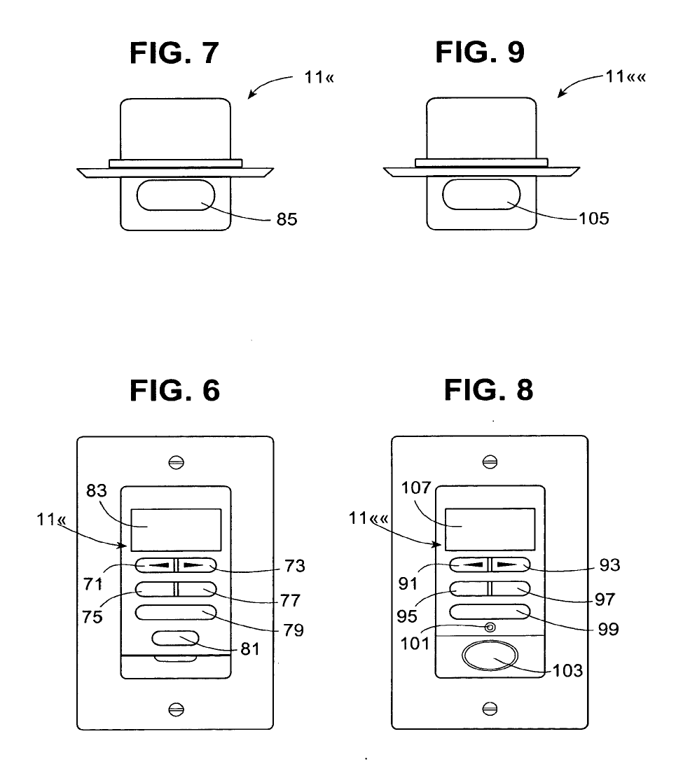

FIGS. 6 and 7 show another embodiment of the timer 11′ of the present invention which is for mounting in a wall box in place of a light switch and which includes similar keys as described with reference to FIGS. 2-4. In this embodiment, a reverse key 71, forward key 73, mode key 75, setting key 77, random key 79 and reset key 81 are provided as soft keys which can be used to operate the timer 11′. In this embodiment, the reverse key 71 and forward key 73 can be additionally used to manually activate a coupled device for a preset period of time (e.g., 5 minutes). Additionally, an on/off switch 85 is provided at the top of the timer. A display 83 is provided for displaying the time, date and functions of the timer (e.g., zip code mode, random mode, manual mode, 7-5-2 mode, etc. The soft keys are actuated by a user in conjunction with information shown on the display 83 to set the timer in accordance with the various modes of operation of the present invention.

In another embodiment (not shown), the timer of the present invention may be a free standing table top unit having a similar design to the embodiments shown in FIGS. 2-7, except that the table top timer should be configured with an electrical outlet which can accommodate a two or three wired cord of the device to which it is to be coupled. The table top timer may be wall mounted, if desired.

In another embodiment, a motion sensor can be provided in the timer which will automatically switch on the device (e.g., lights, appliances, etc.) when movement is detected within a particular area. Conventional motion sensors such as Passive Infrared (“PIR”) sensors and Pyroelectric Infrared sensors, such as sensor model Nos. RE200B, RE431B, RE46B sold by Nippon Ceramic Co., Ltd., for example, are suitable for use with the present invention. As shown in FIG. 8, the timer 11″ of this embodiment is wall mounted and may have a similar design as the embodiment shown in FIGS. 6 and 7, except that it includes a motion sensor. More particularly, as shown in FIGS. 8 and 9, in this embodiment, a reverse key 91, forward key 93, mode key 95, setting key 97, random key 99 and reset key 101 are provided as soft keys which can be used to operate the timer 11″. In this embodiment, the reverse key 91 may be used to manually adjust the coupled device to activate for a preset period of time (e.g., 5 minutes). A motion sensor 103 is also provided which will activate the timer and coupled device when motion is detected. In this embodiment, the forward key 73 can be used to activate the motion detection sensor 103. In this embodiment, the timer may remain activated for a predetermined time (e.g. 5-15 minutes) or until manually reset using the keys. Additionally, an on/off switch 105 is provided at the top of the timer. A display 107 is provided for displaying the time, date and functions of the timer (e.g., zip code mode, random mode, manual mode, 7-5-2 mode, etc. The soft keys are actuated by a user in conjunction with information shown on the display 107 to set the timer in accordance with the various modes of operation of the present invention.

Similarly, a sound detector (see FIG. 1) can be implemented in lieu of, or addition to, the motion sensor to automatically switch on the device when sound is detected within a certain range of distances (e.g., 0-6 feet, 6-12 feet, etc.) of the detector. Conventional sound detectors are suitable for the present invention. Additionally, a voice recognition system (see FIG. 1) can be implemented in the timer in lieu of, or in addition to, the keys for operating the timer. In this regard, the timer can be activated and/or operated in response to voice. Conventional voice recognition systems, such as Sensory Voice Recognition Chips and/or SUNPLUS SPC501, for example, are suitable for the timer of the present invention.

In operation, the timer is preferably preset with default settings for time, date and zip code (e.g., EST time zone and a 10010 zip code) using methods well known in the art. When presetting the timer, a battery should be included with the timer to preserve these settings until the timer is plugged into an outlet or hard wired in place of an outlet. Alternatively, upon installation, the user sets the local time and date for his geographic location in the timer's clock. This information is displayed and saved in the timer. Next, the user is prompted to enter his zip code (or other geographic indicia) through the use of the zip code key, which can be done using the alphanumeric keypad and/or soft keys. Where the timer is preset with date and time, the software in the timer will automatically adjust the time setting to the local time in the time zone for the entered zip code. Additionally, the timer processes the zip code by searching the database of zip codes and sunset times and adjusts the timer to automatically activate and/or deactivate the device to which it is connected at the sunset times and dates stored in memory for that geographic location. For example, if the user enters the zip code for Portland, Me., the timer will automatically cause the timer to activate and/or deactivate the device to which it is coupled at the sunset and/or sunrise times for each date or time period that is stored in memory for this region. Once the user sets the time, date and enters a geographic indicator, no further action is required by the user. In this regard, on a going forward basis, the timer of the present invention will automatically adjust the activation and/or deactivation time to coincide with the change in sunset and/or sunrise times of the location where it has been installed. Alternatively, the timer may be preset to automatically switch off a device a predetermined number of hours (e.g., 6 hours) after the device is activated by the timer. In such case, the user is given the option of changing this presetting to a time period of choice as to when the device should be switched off.

Finally, it is noted that the timer of the present invention is suitable for use in both residential and industrial applications. For residential applications (e.g., indoor and outdoor household lights, appliances, etc.), the timer should be designed to handle low electrical current. For example, the timer could have a 10 ampere rating. If the timer is for outdoor use, it should be weather resistant and should preferably include a gasket seal. Outdoor timers may also include a re-settable circuit breaker and a stake which can be used to secure the timer in the ground. For heavy duty applications (parking lot lights, heavy duty garden lights, swimming pool filters, etc), the timer of the present invention should be modified to handle greater electrical current. For example, the timer could have a 40 amp/120 volt rating with a single pole/single throw switch or a double pole/single throw switch. Additionally, such timers could include a heavy duty circuit, back up battery system, a tamper proof design (e.g., a lock) to prevent vandalism and/or an electrostatically painted enclosure that withstands temperature extremes.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims and not by the foregoing specification.

I claim:

1. In a timer comprising a connection operable to electrically couple to an electrical device having a first condition and a second condition; a display; an input configured to receive an indicium corresponding to a geographic location; a memory unit comprising a database having stored sunset times for a plurality of geographic locations, wherein the stored sunset times are indexed to geographic indicia for each of said plurality of geographic locations; and a microprocessor operable to control the memory unit and the display, a method of providing random switching of the electrical device from the first condition to the second condition, the method comprising:
(a) entering a specific geographic indicium via the input;
(b) identifying a specific sunset time within the database that corresponds to the specific geographic indicium entered;
(c) generating an activation time correlated to but randomly offset from the specific sunset time identified; and
(d) automatically switching the electrical device from the first condition to the second condition at the activation time.

2. The method of claim 1, wherein the activation time varies by about 5 to 15 minutes on a random basis from the sunset time identified

3. The method of claim 1 further comprising (e) extrapolating a sunset time for additional dates not stored in the database.

4. The method of claim 3, wherein (c) comprises (c. 1) generating an activation time correlated to but randomly offset from the extrapolated sunset time.

5. The method of claim 4, wherein:
(c) comprises (c.1) generating a first activation time correlated to but randomly offset from the specific sunset time identified and (c.2) generating a second activation time correlating to but randomly offset from the specific sunset time identified, wherein the second activation time is different from the first activation time; and
(d) comprises (d.1) switching the electrical device from the first condition to the second condition at each of the first and second activation times.

6. The method of claim 1, wherein the geographic indicia is selected from the group consisting of international mailing codes, U.S. telephone area codes, international telephone dialing codes, city names, region names, longitude, latitude and global positioning data.

7. A method of controlling electrical devices, the method comprising:
(a) obtaining a timer comprising:
a connection operable to electrically couple to an electrical device having a first condition and a second condition;
an input configured to receive an indicium corresponding to a geographic location;
a memory unit including a database comprising a plurality of sunset times for a plurality of geographic locations, wherein the sunset times are indexed to geographic indicia for each of said plurality of geographic locations; and
a microprocessor operable to switch the connected electrical device to the first condition at an activation time, wherein the activation time correlates to but is randomly offset from a specific sunset time stored in the database that is indexed to the geographic indicium received via the input,
(b) connecting the electrical device to the timer connection; and
(c) entering an indicium corresponding to the geographic location,
wherein the timer switches the electrical device to the first condition at the activation time, wherein the timer selectively engages, on a recurring basis, the electrical device at a plurality of activation times correlated to but offset from the stored sunset time, and wherein each activation time is chosen on a random basis.

8. The method of claim 7, wherein:
the database further comprises a plurality of sunrise times for the plurality of geographic locations;
the microprocessor is further operable to switch the connected electrical device from the first condition to the second condition at a deactivation time, wherein the deactivation time correlates to but is randomly offset from a specific sunrise time stored in the database.

9. The method of claim 7, wherein the activation time occurs within about 15 minutes of the sunset time.

10. A timer for controlling electrical devices, the timer comprising:
a connection operable to electrically couple to an electrical device having a first condition and a second condition;
a display;
an input configured to receive an indicium corresponding to a geographic location;
a memory unit including a database comprising stored sunset times for a plurality of geographic locations, wherein the stored sunset times are indexed to geographic indicia for each of said plurality of geographic locations; and
a microprocessor operable to switch the connected electrical device to the first condition at an activation time, wherein the activation time correlates to but is randomly offset from a specific sunset time stored in the database that is indexed to the geographic indicium received via the input,
wherein the timer switches the electrical device to the first condition at the stored sunset time indexed to said geographic indicia received via the input, wherein the timer is operable to selectively engage, on a recurring basis, the electrical device at the activation time correlated to but offset from the stored sunset time, and wherein the activation time is chosen on a random basis.

11. The timer of claim 10, wherein the offset time occurs within about 15 minutes of the sunset time.

12. The timer of claim 10, wherein the offset time varies from about 5 minutes to about 15 minutes from the stored sunset time.

13. The timer of claim 10, wherein:
the microprocessor extrapolates sunset times not stored in the database;
the activation time correlates to but is randomly offset from the extrapolated sunset time; and
the timer switches the electrical device to the first condition at the activation time correlated to but randomly offset from the extrapolated sunset time.

14. The timer of claim 10, wherein:
the database further comprises a plurality of sunrise times for the plurality of geographic locations;
the stored sunrise times are indexed to geographic indicia for each of said plurality of geographic locations; and
the microprocessor is further operable to switch the connected electrical device from the first condition to the second condition at a deactivation time, wherein the deactivation time correlates to but is randomly offset from a specific sunrise time stored in the database.

15. The timer of claim 14, wherein:
the microprocessor extrapolates a sunrise time not stored in the database;
the deactivation time correlates to but is randomly offset from the extrapolated sunrise time; and
the timer switches the electrical device from the first condition to the second condition at the deactivation time correlated to but randomly offset from the extrapolated sunrise time.

16. The timer of claim 10, wherein in the timer selectively operates in a first mode, in which the timer switches the electrical device from the first condition to the second condition at a first sunset time five days a week, and in a second mode, in which the timer switches the device from the first condition to the second condition at a second time for two days a week.
